(19) United States
(12) Patent Application Publication
(10) Pub. No.: US 2018/0300980 A1
(43) Pub. Date: Oct. 18, 2018

(54) SALES APPARATUS, CONTROL METHOD, AND STORAGE MEDIUM

(71) Applicant: FUJITSU LIMITED, Kawasaki-shi (JP)

(72) Inventors: Yuki Iwamura, Edogawa (JP); Toshimitsu SAWAGUCHI, Chiba (JP)

(73) Assignee: FUJITSU LIMITED, Kawasaki-shi (JP)

(21) Appl. No.: 15/917,250

(22) Filed: Mar. 9, 2018

(30) Foreign Application Priority Data
Apr. 14, 2017 (JP) 2017-080840

(51) Int. Cl. G07F 9/02; G06Q 10/08; G06Q 30/02

(52) U.S. Cl. CPC G07F 9/026; G06Q 10/0875; G06Q 30/0238; G06Q 30/0235; G06Q 30/0283

(57) ABSTRACT

A sales apparatus includes a receptacle; a column that houses a plurality of goods to be sold and transports the plurality of goods to the receptacle; a memory in which inventory information indicating an inventory status of the column of the plurality of goods is stored; and a processor coupled to the memory and configured to: update the inventory information each time the plurality of goods are transported from the column to the receptacle, and when referencing the inventory information and detecting that, out of a plurality of specific goods in inventory among the plurality of goods, a plurality of target goods to be subject to selling processing at a first selling price are out of inventory, suppress transportation processing of the plurality of specific goods from the column to the receptacle even when the plurality of specific goods in inventory remain.

### CROSS-REFERENCE TO RELATED APPLICATION

This application is based upon and claims the benefit of priority of the prior Japanese Patent Application No. 2017-80840, filed on Apr. 14, 2017, the entire contents of which are incorporated herein by reference.

### FIELD

The embodiment discussed herein is related to a sales apparatus, a control method, and a storage medium.

### BACKGROUND

In the sale of goods from a vending machine, goods are basically sold at the list prices and therefore the profitability is high. However, recently, the volume of vending machine sale has been on a downward trend because of the influence of low-priced sale in mass merchandisers, convenience stores, and the like.

The sale of goods from a vending machine has an advantage in that salespersons are unnecessary; however, there is a problem in that managing the freshness of goods is difficult. For example, in a beverage vending machine, increasing the time of retaining goods within the vending machine results in the possibility that the goods will undergo quality degradation due to heating or milk separation, or pass the best-before date. If such goods are sold, it will lead to a reduction in customer satisfaction. Disposing items that have been retained long in the vending machine to avoid such a situation increases the losses due to disposal.

As a technique for sales control of goods with a sell-by date when the goods are sold from a vending machine, a sales control method proposes that dispensing of goods beyond their sell-by date be inhibited. In this method, upon detecting that goods have been stocked immediately before the expiry of the sell-by date, switching to discount selling processing is performed. In this method, upon detecting that the sell-by date of goods stocked for a period has expired, switching to sellout processing is performed.

As a vending machine in which goods with a best-before date are sold, a vending machine is proposed that ensures that when the prices of goods that are close to the best-before date are discounted, the user will consider the goods to be inexpensive, which will decrease the quantity of goods whose sell-by dates have expired. In such a vending machine, upon inputting, via a keyboard, the best-before date, a predetermined number of days to promote the sales, and a discount, a central processing unit (CPU) stores these items of data in random access memory (RAM) and decrements the best-before date by using a real-time clock integrated circuit (IC) each time a date is changed. When goods are sold, the CPU determines the remaining number of days from the decremented best-before date to the expiry of the best-before date. If this number of days is less than or equal to the predetermined number of days, then the CPU causes money corresponding to the discount to be refunded. Related art techniques are disclosed in, for example, Japanese Laid-open Patent Publication No. 8-77434 and Japanese Laid-open Patent Publication No. 9-282535.

To reduce the losses due to disposal in a vending machine, it is conceivable to sell goods immediately before the expiry of the sell-by date at a discount as disclosed in the examples of related art techniques. However, in this case, when the goods immediately before the expiry of the sell-by date are sold out after being discounted, there are some cases where even goods in inventory for which a discount is unnecessary are sold at a discounted selling price. In the examples of related art techniques, no account is taken of the selling price after being once discounted. Therefore, in a vending machine, there are some cases where sale is not able to be controlled according to the situation. In view of the foregoing, it is desirable that sale be controlled according to the situation.

### SUMMARY

According to an aspect of the invention, a sales apparatus includes a receptacle; a column that houses a plurality of goods to be sold and transports the plurality of goods to the receptacle; a memory in which inventory information indicating an inventory status of the column of the plurality of goods is stored; and a processor coupled to the memory and configured to: update the inventory information each time the plurality of goods are transported from the column to the receptacle, and when referencing the inventory information and detecting that, among a plurality of specific goods in inventory among the plurality of goods, a plurality of target goods to be subject to selling processing at a first selling price are out of inventory, suppress transportation processing of the plurality of specific goods from the column to the receptacle even when the plurality of specific goods in inventory remain.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a schematic configuration of a sales apparatus according to the present embodiment;

FIG. 2 is a functional block diagram of a selling price control apparatus;

FIG. 3 is a diagram depicting an example of setting database (DB);

FIG. 4 is a diagram depicting an example of a condition DB;

FIG. 5 is a diagram depicting an example of an inventory DB;

FIG. 6 is a diagram illustrating an example of updating of an inventory DB;

FIG. 7 is a diagram illustrating an example of updating of an inventory DB;

FIG. 8 is a diagram depicting an example of a change DB;

FIG. 9 is a diagram depicting an example of a change information DB;

FIG. 10 is a diagram depicting an example of a change information screen;

FIG. 11 is a block diagram illustrating a schematic configuration of a computer that functions as a selling price control apparatus;

FIG. 12 is a diagram illustrating an example of display on a display unit of a sales apparatus;

FIG. 13 is a flowchart illustrating an example of a supply management process;

FIG. 14 is a flowchart illustrating an example of a selling price change process;

FIG. 15 is a flowchart illustrating an example of a selling stop process; and

FIG. 16 is a block diagram illustrating another configuration example of a sales apparatus and a selling price control apparatus.

### DESCRIPTION OF EMBODIMENT

Hereinafter, an example of an embodiment according to disclosed techniques will be described in detail with reference to the accompanying drawings. In the present embodiment, a vending machine that sells beverages will be described by way of example as a sales apparatus of the disclosed techniques.

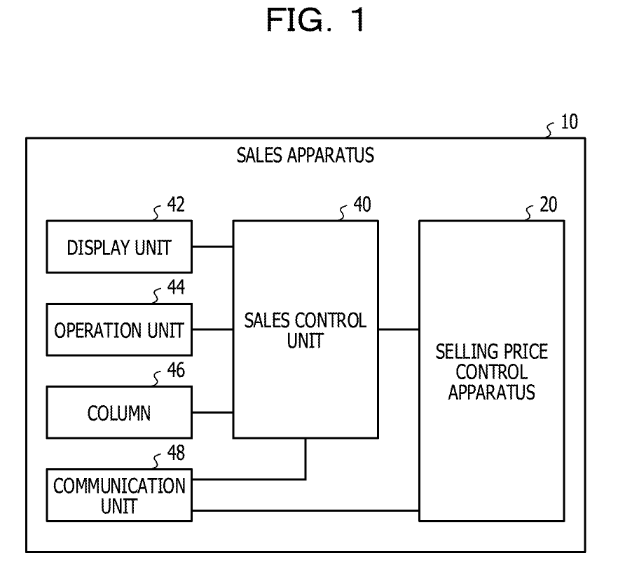

As illustrated in FIG. 1, a sales apparatus 10 according to the present embodiment includes a selling price control apparatus 20, a sales control unit 40, a display unit 42, an operation unit 44, a column 46, and a communication unit 48.

The display unit 42 includes a digital indicator for displaying the selling price and selling status of each item of goods that is sold in the sales apparatus 10, a lamp, a display used for displaying an advertisement and so on, or the like. In the display unit 42, display and lighting of the selling prices, selling status, advertisements, and the like are performed based on information of which the control unit 40 has notified the display unit 42.

The operation unit 44 includes a button that is pressed down at the time of selection of an item of goods. When any button is pressed down, the operation unit 44 notifies the sales control unit 40 of identification information (hereinafter referred to as a column code) of the column 46 where an item corresponding to the pressed button is stored.

Part of the display unit 42 and the operation unit 44 may be implemented as a touch panel display provided in the front surface of the sales apparatus 10. For example, an item of goods may be selected by touching an image of the item or a button displayed as an icon of the item on a touch panel display so as to display the image, selling price, selling status, and the like of the corresponding item on the touch panel display.

The column 46 is an area where items of goods are supplied and stored as inventory. The sales apparatus 10 includes a plurality of columns 46, and one type of goods is supplied and stored in one or more columns 46. Items of goods stored in each column 46 are dispensed in the order in which the items have been supplied to the columns 46. Each column 46 has a mechanism of transporting items of goods stored in the column 46 to an item receptacle. Upon being notified by the sales control unit 40 of an instruction to dispense goods, the column 46 dispenses one item of goods stored in the column 46 and transports the item to the item receptacle.

The communication unit 48 is, for example, a wireless communication device using Wi-Fi (registered trademark) or the like.

The sales apparatus 10 includes a money device (not illustrated) including a money acceptor, a coin and bill determination mechanism, a change receptacle, and the like. The sales apparatus 10 may further include a person sensor for sensing whether a person is in front of the sales apparatus 10.

The sales control unit 40 controls each mechanism of the sales apparatus 10. Specifically, the sales control unit 40 displays the selling price set for each item and the selling status of each item on the display unit 42 such as a digital indicator associated with the item. The sales control unit 40 may perform control so that an advertisement or a message is displayed on the display unit 42 such as a display.

Upon being notified by the operation unit 44 of a column code, the sales control unit 40 notifies the column 46 indicated by the column code of the notification of an instruction to dispense goods.

The sales control unit 40 acquires the number of items of goods supplied to the column 46 and the number of items of goods discharged from the column 46 that are input to the sales apparatus 10 by a route salesperson, for example, when the route salesperson discharges the items in inventory and supplies the items of goods. The sales control unit 40 adds information that identifies the supplied or discharged items of goods and the column code as well as a time stamp indicating the date and time when the supply and discharge are performed, to the acquired numbers of supplied and discharged items, thereby generating column-by-column input and output data. In the present embodiment, information that identifies goods is represented by a combination of identification information of the goods (hereinafter referred to as a goods code) and HC classification indicating the selling status (described later in detail). The sales control unit 40 stores the generated column-by-column input and output data in a predetermined storage area.

The number of supplied or discharged items may be directly input to the selling price control apparatus 20 by a route salesperson. Alternatively, the number may be input from a handy terminal held by the route salesperson via the communication unit 48 to the selling price control apparatus 20. Under the condition where each column 46 is provided with a counter that counts the number of supplied items or dispensed items, the sales control unit 40 may acquire input and output data by reading the value of this counter.

The sales control unit 40 adds, to a column code of which the sales control unit 40 has been notified by the operation unit 44, a time stamp indicating the date and time when the notification has been received and the item code and HC classification of an item stored in the column 46 of interest to generate sales data, and stores the generated sales data in the predetermined storage area. In the present embodiment, one piece of sales data corresponds to sale of one item of goods. The sales control unit 40 transmits the sales data and the column-by-column input and output data stored in the predetermined storage area as the sales performance and inventory status at a certain timing via the communication unit 48 to an outside server. The sales control unit 40 calculates the number of items in inventory for every column 46 or for every goods based on the column-by-column input and output data. The sales control unit 40 then may transmit the calculated number of items in inventory together with the sales data to an outside server.

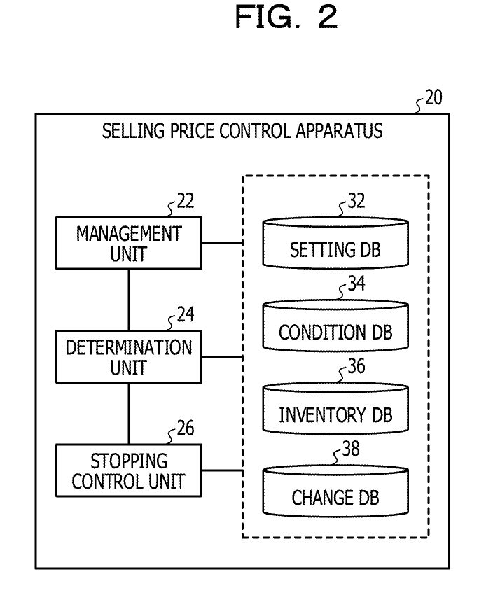

The selling price control apparatus 20, as illustrated in FIG. 2, functionally includes a management unit 22, a determination unit 24, and a stopping control unit 26. A setting data base (DB) 32, a condition DB 34, an inventory DB 36, and a change DB 38 are stored in a predetermined storage area of the selling price control apparatus 20. The selling price control apparatus 20 is an example of a control unit of a sales apparatus according to disclosed techniques.

The management unit 22 receives setting information regarding a change in selling price and stores the setting information in the setting DB 32. The management unit 22 receives condition information regarding conditions of the case of changing a selling price and stores the condition information in the condition DB 34. The setting information and the condition information may be, for example, input to the selling price control apparatus 20 by a route salesperson. Alternatively, these information may be input via the communication unit 48 from an outside device such as a management center.

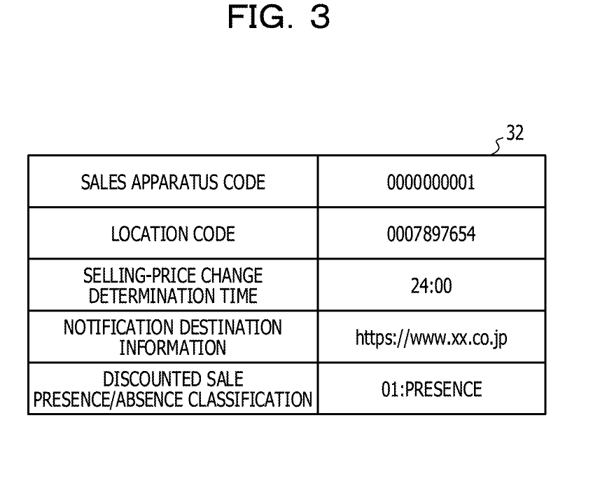

Here, FIG. 3 illustrates an example of the setting DB 32. In the example of FIG. 3, information on “sales apparatus code”, “location code”, “selling-price change determination time”, “notification destination information”, and “discounted sale presence/absence classification” is stored in the setting DB 32. “Sales apparatus code” is identification information of the sales apparatus 10. “Location code” is information indicating a location at which the sales apparatus 10 is installed. “Selling-price change determination time” is a time at which a process of determining whether to perform a discounted sale (described later in detail) is executed. For example, the selling-price change determination time may be set in a time zone late at night or the like in which goods are not so much sold in the sales apparatus 10. “Notification destination information” is the address of an outside server to which change information described later is to be transmitted.

“Discounted sale presence/absence classification” is setting of whether to sell goods at a discount when conditions of a discounted sale are satisfied. In the present embodiment, the case where goods are sold at a discount when conditions of a discounted sale are satisfied is represented as “01: presence”, and the case where goods are not sold at a discount although conditions of a discounted sale are satisfied is represented as “00: absence”. This makes it possible to selectively set whether to perform a discounted sale, taking into account a situation where goods are expected to be sold without a discount, for example, according to day of week or season.

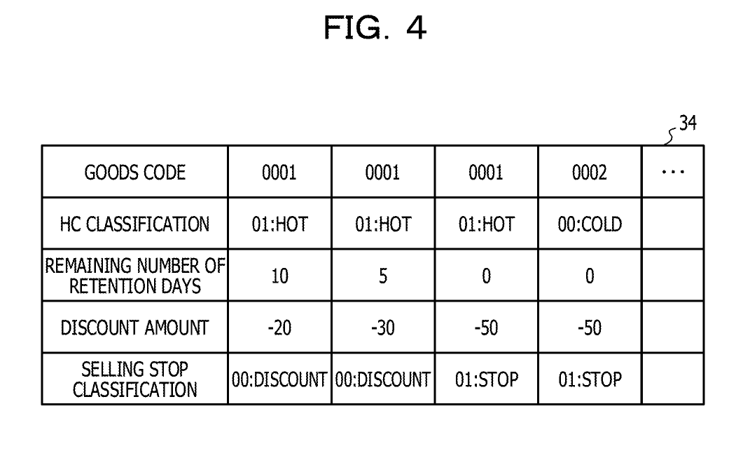

FIG. 4 illustrates an example of the condition DB 34. In the example of FIG. 4, information on “goods code”, “HC classification”, “the remaining number of retention days”, “discount amount”, and “selling stop classification” is stored. “HC classification” is information indicating whether goods indicated by “goods code” when being sold in the sales apparatus 10 is in a hot state or in a cold state. With quality degradation due to heating of goods taken into account, even the same goods may have different conditions of a discounted sale between its hot state and its cold state. In the example in FIG. 4, the case where goods are sold in the hot state is represented as “01: HOT”, and the case where goods are sold in the cold state is represented as “00: COLD”.

The “remaining number of retention days” is the remaining number of days until expiry of the period in which goods are retainable in the column 46. The period in which goods are retainable in the column 46 is preset in consideration of the best-before date of the goods, the time at which quality degradation of the goods is expected to occur because of heating degradation and milk separation, and the like. “Discount amount” is the amount of money by which the list price is reduced in accordance with “the remaining number of retention days”. For example, in the example in FIG. 4, the case is represented where, when goods with Goods Code=0001 are sold in the hot state, the selling price of the goods whose remaining number of retention days has become 10 is changed to the amount of money obtained by subtracting 20 yen from the list price.

“Selling stop classification” is information indicating whether to sell goods at a price obtained by subtracting the “discount amount” from the list price or to stop selling when the remaining number of retention days of goods in the column 46 has reached the “remaining number of retention days” defined in the condition DB 34, that is, when the conditions of a discounted sale are satisfied. In the example in FIG. 4, the case where goods are to be sold at a price obtained by subtracting the “discount amount” from the list price is represented as “00: discount”, and the case where selling is to be stopped is represented as “01: stop”. Depending on the remaining number of retention days or the characteristics of goods, it is appropriate in some cases to stop selling, not to sell goods at a reduced price. Therefore, it is possible to selectively set “selling stop classification”, either selling at a reduced price or stopping selling.

A plurality of pieces of condition information for each combination of the goods code and the HC classification are able to be stored in the condition DB 34. In the example in FIG. 4, for the goods with Goods Code=0001 and HC Classification=01: HOT, information on three conditions is stored where the price is reduced by 20 yen when the remaining number of retention days is 10, the price is reduced by 30 yen when the remaining number of retention days is five, and selling is stopped when the remaining number of retention days is zero. For “discount amount” and “selling stop classification”, suitable values may be set in accordance with the list price, the characteristics of goods, the characteristics of an installation location of the sales apparatus 10 indicated by the location code, and the like.

The management unit 22 acquires column-by-column input and output data and sales data from the sales control unit 40 and stores the acquired data in the inventory DB 36. The inventory DB 36 is a database for managing the number of items in inventory in a situation where the remaining number of retention days of the items is able to be grasped for every column 46.

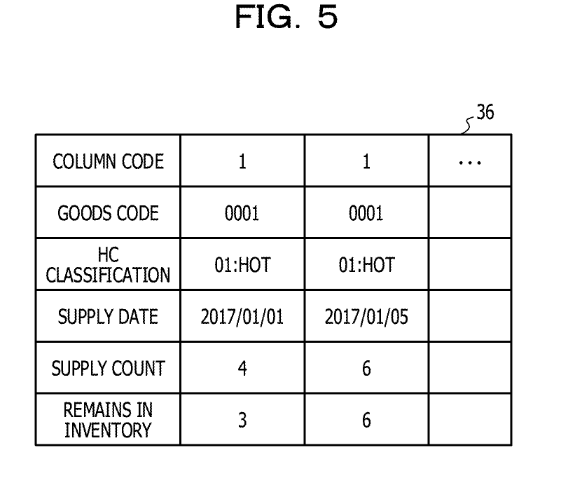

Here, FIG. 5 illustrates an example of the inventory DB 36. In the example of FIG. 5, information on “column code”, “goods code”, “HC classification”, “supply date”, “supply count”, and “remains in inventory” is stored in the inventory DB 36. “Column code” is identification information of each of a plurality of columns 46 in the sales apparatus 10. “Supply date” is a date on which items are supplied to the column 46, and “supply count” is the number of items supplied to the column 46. “Remains in inventory” is the number of items remaining in inventory on each “supply date” of items stored in each column 46.

When the column-by-column input and output data acquired from the sales control unit 40 is input and output data indicating supply of items, the management unit 22 stores the input and output data as a new record in the inventory DB 36. At this point, the management unit 22 stores the same value as in the “supply count” field in the “remains in inventory” field. When the column-by-column input and output data is input and output data indicating discharge of items, the management unit 22 identifies, in the inventory DB 36, records each in which the “column code”, “goods code”, and “HC classification” are the same as in the input and output data and in which the value of “remains in inventory” is greater than or equal to one. The management unit 22 then subtracts the number of discharged items indicated by the input and output data from the number of “remains in inventory” in order from the record of the oldest “supply date” among the identified records.

For example, when the input and output data indicates Column Code=1, Goods Code=0001, HC Classification=01: HOT, and four as the number of discharged items, in the example in FIG. 5, three is subtracted from the value of “remains in inventory” of the first-column record with the oldest “supply date”. Next, one is subtracted from the value of “remains in inventory” of the second-column record. As a result, the value of “remains in inventory” of the first-column record is zero, and the value of “remains in inventory” of the second-column record is five.

Upon acquiring the sales data from the sales control unit 40, the management unit 22 subtracts, for one piece of sales data, one from the value of “remains in inventory” of the corresponding record of the inventory DB 36, as is the case with the input and output data indicating discharge of items. The management unit 22 delivers the acquired sales data to the stopping control unit 26.

At the selling price change timing indicated by “selling-price change determination time” stored in the setting DB 32, the determination unit 24 references the inventory DB 36. Then, for every column 46, the determination unit 24 calculates the remaining number of retention days on each “supply date” indicated by a record in which the value of “remains in inventory” is greater than or equal to one. For example, when the retention time limit is set in advance, for example, as 15 days after an item has been supplied to the column 46, the determination unit 24 calculates the remaining number of days by subtracting the number of days that have elapsed from the “supply date” to the current from 15 days. By using the condition DB 34, the determination unit 24 determines a selling price in accordance with the remaining number of retention days calculated for every column 46. If the calculated remaining number of retention days does not satisfy the conditions of a discounted sale defined in the condition DB 34, the determination unit 24 determines the selling price of an item of goods stored in the column 46 of interest as the list price.

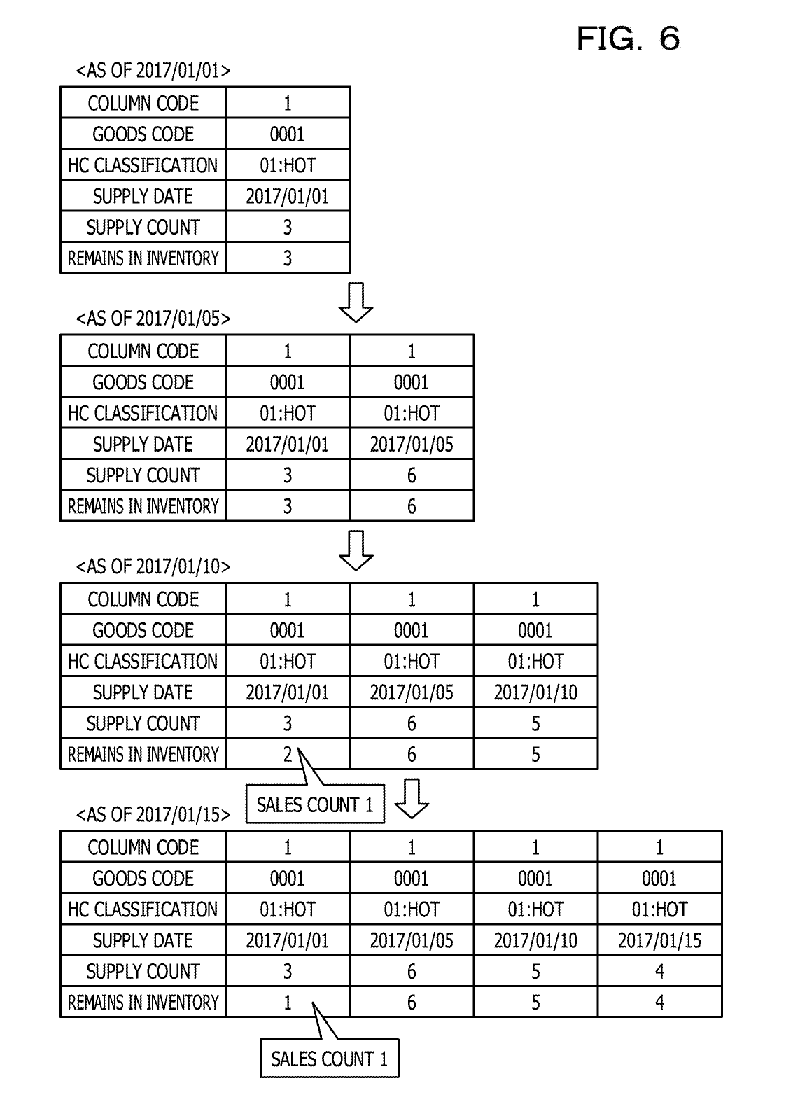

For example, it is assumed that, for the column code 46 with Column Code=1, the determination unit 24 has acquired input and output data and sales data as follows. Since Goods Code=0001 and HC Classification=01: HOT are shared by items supplied to the column 46 with Column Code=1, description thereof is omitted hereinafter. In this case, the inventory DB 36 is updated as illustrated in FIG. 6.

1. Input and output data with Supply Date=2017/01/01 and Supply Count=3

2. Input and output data with Supply Date=2017/01/05 and Supply Count=6

3. Input and output data with Supply Date=2017/01/10 and Supply Count+5

4. One piece of sales data (Sales Count=1) with Sale Date=2017/01/10

5. Input and output data with Supply Date=2017/01/15 and Supply Count=4

6. One piece of sales data (Sales Count=1) with Sale Date=2017/01/15

The list price of goods with Goods Code=0001 and HC Classification=01: HOT is assumed to be 150 yen. Assuming that the retention time limit of the goods is 15 days, the determination unit 24 calculates that the remaining number of retention days of an item stored in the column 46 with Column Code=1 is 15 days as of 2017/01/01. With reference to the condition DB 34 in FIG. 4, the remaining number of retention days of 15 days does not satisfy the conditions of a discounted sale. Therefore, the determination unit 24 does not change the selling price of the goods as of 2017/01/01.

As of 2017/01/05, the determination unit 24 calculates that the remaining number of retention days of the item supplied on 2017/01/01 is 10 days. In this case, the conditions of a discounted sale are satisfied. Therefore, the determination unit 24 determines that, as of 2017/01/05, the selling price of the goods is 130 yen, which is obtained by subtracting 20 yen as a discount amount in accordance with the remaining number of retention days from 150 yen as the list price.

As of 2017/01/10, the determination unit 24 calculates that the remaining number of retention days of the item supplied on 2017/01/01 is 5 days, and the remaining number of retention days of the item supplied on 2017/01/05 is 10 days. In this case, the determination unit 24 determines that, as of 2017/01/10, the selling price of the goods is 120 yen, which is obtained by subtracting 30 yen as a discount amount in accordance with the remaining number of retention days of the item supplied on 2017/01/01 to be sold earlier than the item supplied on 2017/01/05.

As of 2017/01/15, the determination unit 24 calculates that the remaining number of retention days of the item supplied on 2017/01/01 is 0 days, the remaining number of retention days of the item supplied on 2017/01/05 is 5 days, and the remaining number of retention days of an item supplied on 2017/01/10 is 10 days. In this case, since the item with the remaining number of retention days of 0 days is present as of 2017/01/15, the determination unit 24 determines to stop selling the goods according to the “selling stop classification” of the condition DB 34.

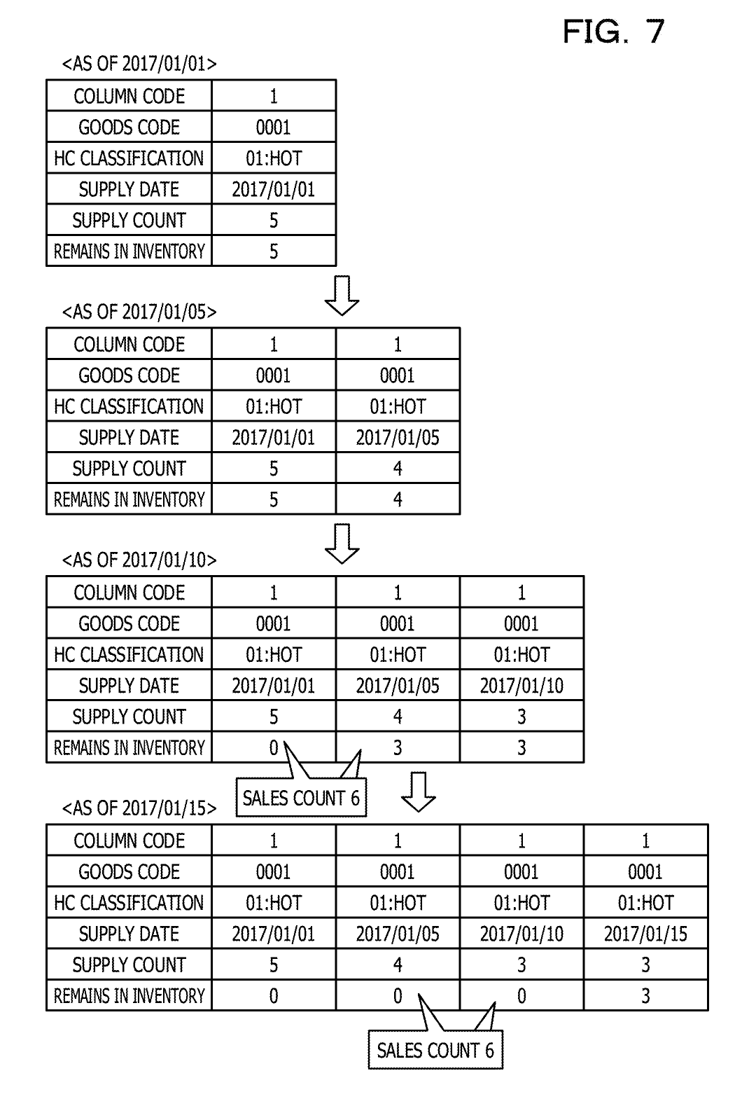

As another example, the input and output data and sales data as mentioned below are assumed to be acquired. In this case, the inventory DB 36 is updated as illustrated in FIG. 7.

1. Input and output data with Supply Date=2017/01/01 and Supply Count=5

2. Input and output data with Supply Date=2017/01/05 and Supply Count=4

3. Input and output data with Supply Date=2017/01/10 and Supply Count=3

4. Six pieces of sales data (Sales Count=6) on Sale Date=2017/01/10

5. Input and output data with Supply Date=2017/01/15 and Supply Count=3

6. Six pieces of sales data (Sales Count=6) on Sales Date=2017/01/15

As of 2017/01/05, the determination unit 24 calculates that the remaining number of retention days of items of goods supplied on 2017/01/01 is 10 days. The determination unit 24 then determines that the selling price of the goods is 130 yen, which is obtained by subtracting 20 yen as a discount amount in accordance with the remaining number of retention days from 150 yen as the list price.

As of 2017/01/10, the items supplied on 2017/01/01 have been sold and dispensed and therefore the number of the items remaining in inventory is zero. Accordingly, the determination unit 24 determines that the selling price of the goods is 130 yen, which is obtained by subtracting 20 yen as a discount amount in accordance with the remaining number of retention days of 10 days calculated for the items supplied on 2017/01/05. That is, there is no change from the selling price determined on 2017/01/05.

As of 2017/01/15, the items supplied on 2017/01/05 and the items supplied on 2017/01/10 have been sold and dispensed and the numbers of these items remaining in inventory are zero. Accordingly, the determination unit 24 determines that there are no items that satisfy the conditions of a discounted sale, and returns the selling price of the goods to the list price.

For goods to be sold at a discount among goods whose selling prices are to be changed, the determination unit 24 stores the changed contents of the selling price in the change DB 38.

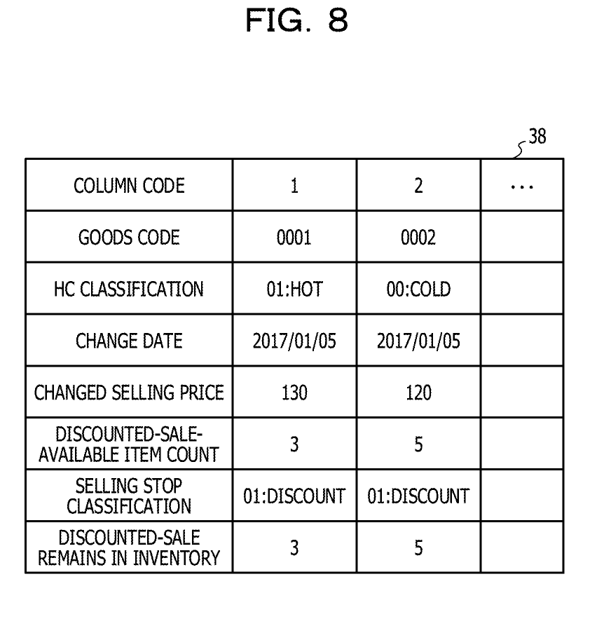

Here, FIG. 8 illustrates an example of the change DB 38. In the example in FIG. 8, information on “column code”, “goods code”, “HC classification”, “change date”, “changed selling price”, “discounted-sale-available item count”, “selling stop classification”, and “discounted-sale remains in inventory” is stored in the change DB 38.

“Discounted-sale-available item count” is the number of items to be sold at a reduced selling price, or the number of items remaining in inventory whose remaining number of retention days has become the number used for the determination of a selling price after a discount. For example, in the case in FIG. 6, it is assumed that, as of 2017/01/05, the determination unit 24 determines 130 yen as a selling price after a discount based on the remaining number of retention days of 10 days on the supply date of 2017/01/01. In this case, the determination unit 24 stores “3” in “remains in inventory” of a record on the supply date of 2017/01/01 in “discounted-sale-available item count”. “Selling stop classification” is information acquired from the condition DB 34. The value obtained by subtracting the number of sold items from the value of “discounted-sale-available item count” is stored in “discounted-sale remains in inventory”.

The determination unit 24 notifies the sales control unit 40 of the column code of the column 46, in which goods whose selling price is to be changed are stored, and the selling price after the change. This allows the sales control unit 40 to perform control, such as changing display in the display unit 42 and changing the settings of the money device.

The determination unit 24 acquires a sales apparatus code and a location code from the setting DB 32. The determination unit 24 then creates change information including information on the sales apparatus code, location code, goods code, HC classification, selling prices before and after the change, and the number of items available for a discounted sale. The determination unit 24 acquires a notification destination from the setting DB 32. The determination unit 24 then transmits the created change information to an outside server, which is the notification destination, via the communication unit 48.

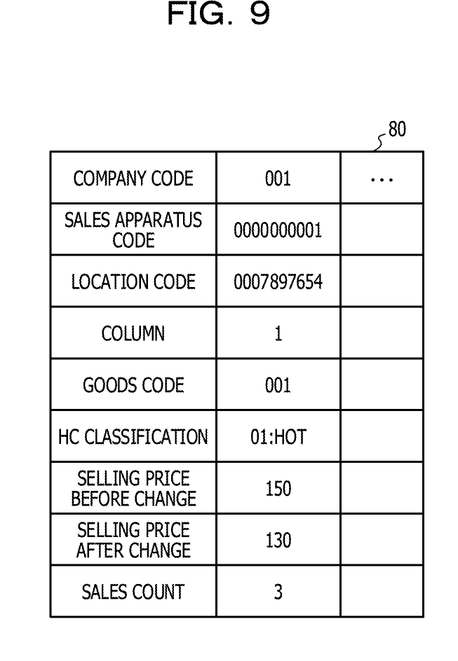

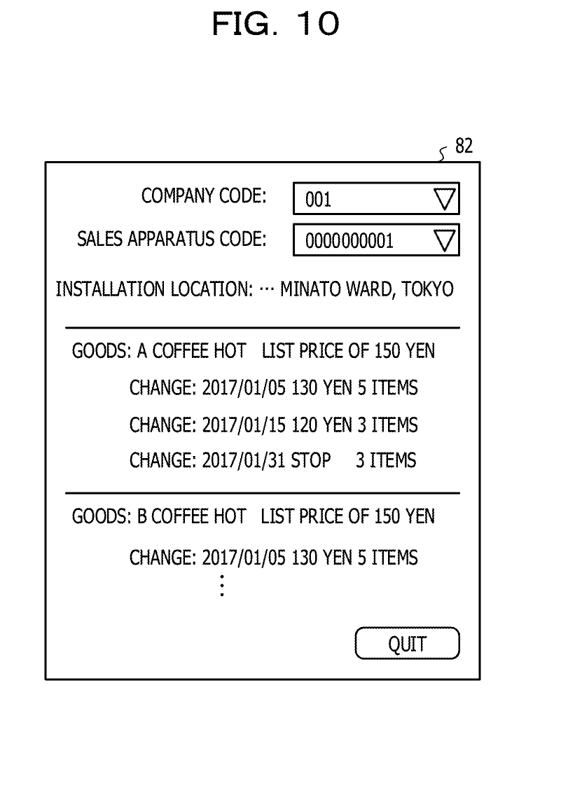

In the outside server, the received change information is stored in a change information DB 80, for example, as illustrated in FIG. 9. Providers of goods, such as beverage makers and owners of vending machines, access the outside server from personal computers, smart phones, or the like and verify change information stored in the change information DB 80. For example, a change information screen 82 as illustrated in FIG. 10 may be displayed in an information processing terminal used by a provider.

The example in FIG. 10 is an example in which a provider specifies his or her own company code and a sales apparatus code and, in the change information DB 80, change information associated with the specified company code and sales apparatus code is displayed. For “installation location” in the example in FIG. 10, an address master in which the location code and an address indicating the installation location are stored to be associated with each other is managed separately in an outside server. Then, in the change information DB 80, an address corresponding to “location code” associated with the specified company code and sales apparatus code may be acquired from the address master. For information on the goods name and the list price in the example in FIG. 10, a goods master in which the information on the goods name, the list price, and the like is stored to be associated with a goods code may be managed separately in an outside server and be acquired by referencing this goods master.

For example, based on change information stored in the change information DB 80, the outside server may use mail or the display screen of an application to notify a user registered as a member in advance (a purchaser of goods) of information on the sales apparatus 10 that sells goods at a discount. The selling-price control apparatus 20 may broadcast information via the communication unit 48 so as to notify an information processing terminal, such as a smart phone, held by the user located near the sales apparatus 10 of information on a discounted sale.

When sales data is delivered from the management unit 22, the stopping control unit 26 subtracts one for one piece of sales data from the value of “discounted-sale remains in inventory” of a record in the change DB 38 in which “column code”, “goods code”, and “HC classification” are the same as those of the sales data. If, in the change DB 38, the value of “discounted-sale remains in inventory” has become zero, the stopping control unit 26 sends a selling stop command to the sales control unit 40 to stop selling goods of interest. One reason for this is that if selling at a reduced selling price continues even after the number of items remaining in inventory after a discounted sale has become zero, items whose remaining number of retention days is sufficient and for which a discount is unnecessary are to be sold at a discount. Another reason is that if the selling price is changed immediately after the number of items remaining in inventory after a discounted sale has become zero, there are some cases where the selling price changes while a plurality of items are being continuously purchased and the selling price changes immediately before purchase is made, which might lead to confusion.

When no purchase action of the user on the sales apparatus 10 has not been detected for at least a given time after the selling stop command was sent, the stopping control unit 26 instructs the determination unit 24 to determine a selling price of the goods of interest. The presence or absence of a purchase action of the user is able to be determined, for example, by detecting the presence or absence of an operation of the display unit 44 or the presence or absence of display on the display unit 42 indicating that goods have been purchased. In the case where the sales apparatus 10 includes a person sensor, the determination may be made depending on the presence or absence of detection of a person by the person sensor.

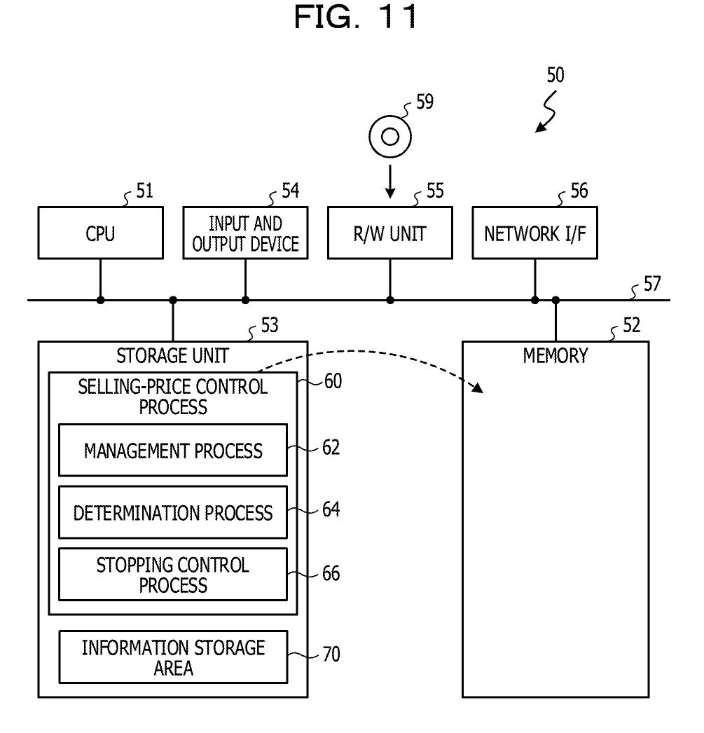

The selling-price control apparatus 20 may be implemented, for example, by a computer 50 illustrated in FIG. 11. The computer 50 includes a central processing unit (CPU) 51, memory 52 as a temporary storage area, a nonvolatile storage unit 53. The computer 50 includes an input and output device 54, a read/write (R/W) unit 55 that controls reading and writing data from and to a storage medium 59, and a communication interface (I/F) 56 coupled to a network such as the Internet. The CPU 51, the memory 52, the storage unit 53, the input and output device 54, the R/W unit 55, and the communication I/F 56 are coupled to each other via a bus 57.

The storage unit 53 may be implemented by a hard disk drive (HDD), a solid state drive (SSD), flash memory, or the like. A selling-price control program 60 for causing the computer 50 to function as the selling-price control apparatus 20 is stored in the storage unit 53 as a storage medium. The selling-price control program 60 includes a management process 62, a determination process 64, and a stopping control process 66. The storage unit 53 includes an information storage area 70 in which information for configuring each of the setting DB 32, the condition DB 34, the inventory DB 36, and the change DB 38 is stored.

The CPU 51 reads the selling-price control program 60 from the storage unit 53 and loads it into the memory 52 to sequentially execute processes included in the selling-price control program 60. The CPU 51 operates as the management unit 22 illustrated in FIG. 2 by executing the management process 62. The CPU 51 operates as the determination unit 24 illustrated in FIG. 2 by executing the determination process 64. The CPU 51 operates as the stopping control unit 26 illustrated in FIG. 2 by executing the stopping control process 66. The CPU 51 reads information from the information storage area 70 to load each of the setting DB 32, the condition DB 34, the inventory DB 36, and the change DB 38 into the memory 52. Thus, the computer 50 executing the selling control program 60 functions as the selling-price control apparatus 20. The CPU 51 that executes programs is hardware.

Next, operations of the sales apparatus 10 according to the present embodiment will be described.

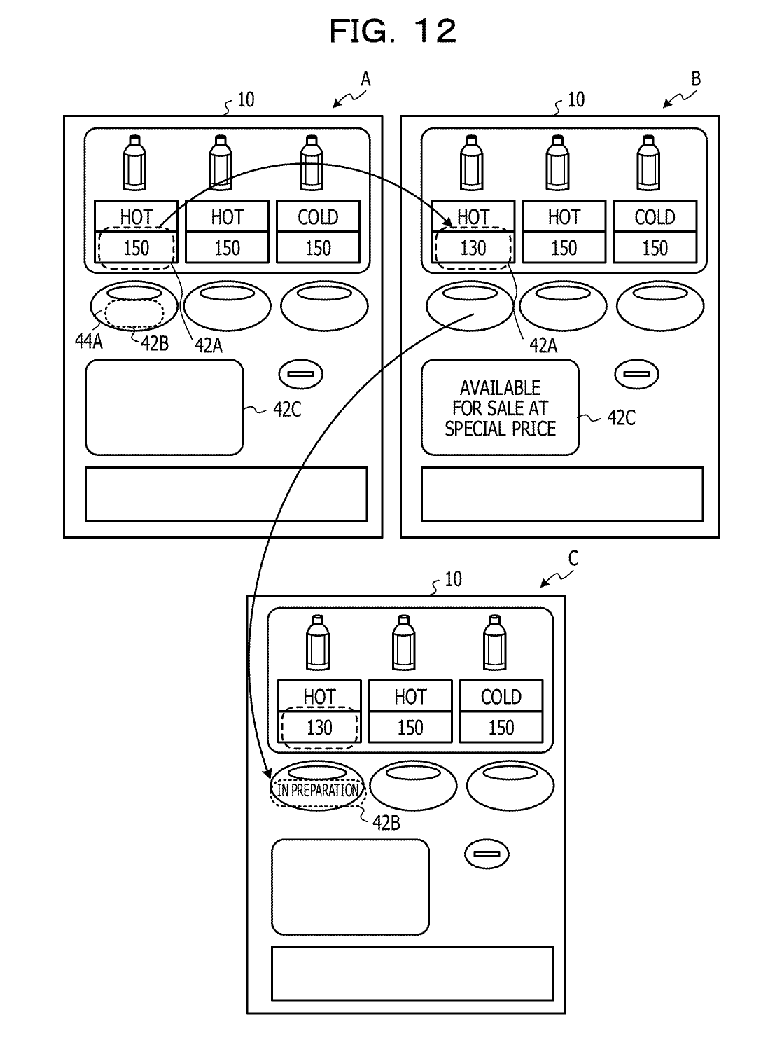

During operation of the sales apparatus 10, the sales control unit 40 of the sales apparatus 10 displays the selling price set for each goods and the selling status of each goods on the display unit 42 such as a digital indicator associated with each goods. FIG. 12 is a schematic diagram of the front surface of the sales apparatus 10. In the example in FIG. 12, the case where a digital indicator 42A for displaying the selling price of each goods, a lamp 42B indicating the selling status of goods, and a display 42C capable of displaying an arbitrary image such as an advertisement, a message, or the like are included as the display unit 42 is illustrated. The lamp 42B is the display unit 42 that causes, for example, characters “in preparation” or the like to be lighted up. In the example in FIG. 12, the lamp 42B is arranged in an operation button 44A, which is an example of the operation unit 44. A state A illustrated in FIG. 12 is assumed to indicate a state where all of the goods are sold at the list prices and there are no goods that are out of inventory.

When the user presses down any operation button 44A in order to purchase goods, the sales control unit 40 is notified of the column code of the column 46 in which goods corresponding to the pressed operation button 44A are stored. The sales control unit 40 notifies the column 46 indicated by the column code of the notification of an instruction to dispense goods. The column 46 of interest outputs one item of goods stored in the column 46 and transports the item to the item receptacle. Upon notified of the column code by the operation button 44A, the sales control unit 40 generates sales data and stores the sales data in a given storage area. When, for example, an item of goods in inventory is discharged or an item of goods is supplied by a route salesperson, the sales control unit 40 generates column-by-column input and output data and stores the generated column-by-column input and output data in the predetermined storage area.

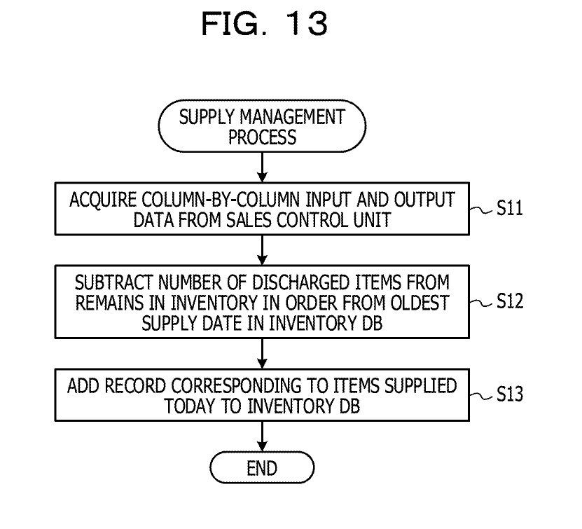

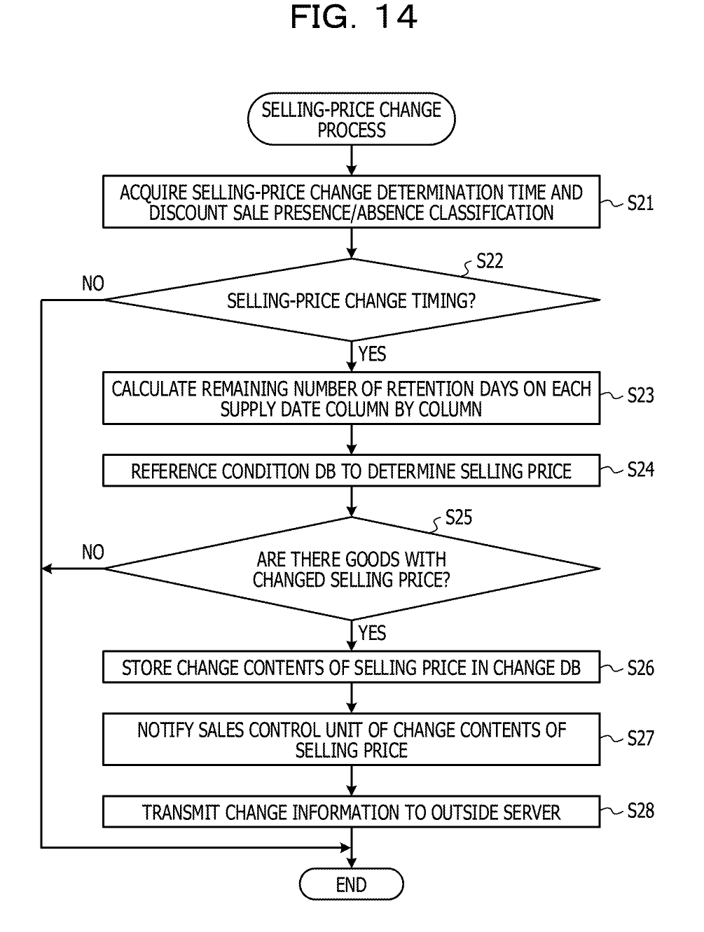

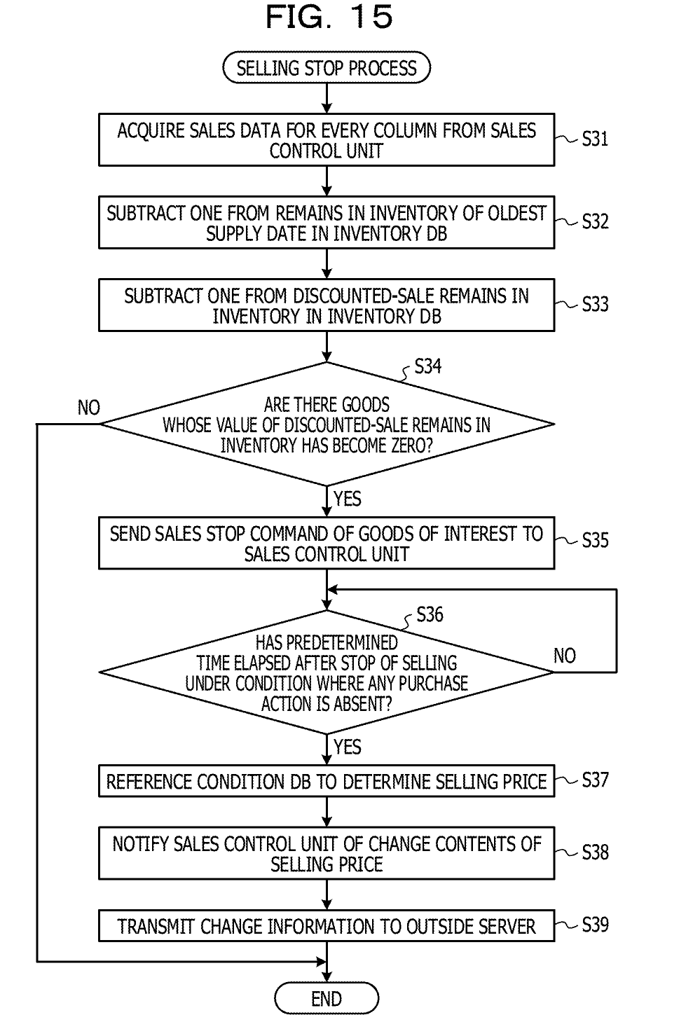

When, for example, items of goods in inventory are discharged or items of goods are supplied by a route salesperson, the goods and the number of discharged items of goods or the number of supplied items of goods are stored in the sales apparatus 10 by using an outer device (for example, a handy terminal or the like). At this point, in the selling-price control apparatus 20, the supply management process illustrated in FIG. 13 is executed. During operation of the sales apparatus 10, the selling-price change process illustrated in FIG. 14 and the selling stop process illustrated in FIG. 15 are repeatedly executed at regular time intervals. Hereinafter, each of the supply management process, the selling-price change process, and the selling stop process will be described in detail. Prior to starting of each process, the management unit 22 receives setting information about a change of a selling price and condition information about conditions of the case where a selling price is changed, which have been stored respectively in the setting DB 32 and the condition DB 34. The supply management process, the selling-price change process, and the selling stop process are examples of the selling-price control method of the disclosed techniques.

First, the supply management process illustrated in FIG. 13 will be described.

In S11, the management unit 22 acquires column-by-column input and output data including information on a column code, a goods code, HC classification, the date of supply or the date of discharge, and the number of supplied items or the number of discharged items from the sales control unit 40.

Next, in S12, based on the input and output data indicating discharge of items, the management unit 22 identifies, in the inventory DB 36, records each in which “column code” and “goods code” are the same as in the input and output data and the value of “remains in inventory” is greater than or equal to one. The management unit 22 then subtracts the number of discharged items indicated by the input and output data from “remains in inventory” in order from the record of the oldest “supply date” among the identified records.

Next, in S13, the management unit 22 stores each piece of input and output data indicating supply of items as a new record in the inventory DB 36. At this point, the management unit 22 stores, in the “remains in inventory” field, the same value as in the “supply count” field. Thus, the supply management process is complete.

Next, the selling-price change process illustrated in FIG. 14 will be described.

In S21, the determination unit 24 acquires information on “selling-price change determination time” and “discount sale presence/absence classification” from the setting DB 32.

Next, in S22, the determination unit 24 determines whether the selling-price change timing has been reached by determining whether “discounted sale presence/absence classification” is “01: presence” and “selling-price change determination time” has been reached. If the selling-price change timing has been reached, the process proceeds to S23. If not, the selling-price change process is complete.

In S23, the determination unit 24 references the inventory DB 36 to calculate, for every column 46, the remaining number of retention days on “supply date” indicated by each of records in which the value of “remains in inventory” is greater than or equal to one.

Next, in S24, the determination unit 24 determines a selling price in accordance with the remaining number of retention days calculated for every column 46 from the condition DB 34. If the calculated remaining number of retention days does not satisfy the condition of a discounted sale defined in the condition DB 34, the determination unit 24 determines that the selling price of goods stored in the column 46 is the list price.

Next, in S25, the determination unit 24 determines whether there are goods for which the selling price determined in the above S24 is a price changed from the currently set selling price. If there are goods whose selling price has changed, the process proceeds to S26. If there are no goods whose selling price has changed, the selling-price change process is complete.

In S26, for goods to be sold at a discount among goods whose selling prices are to be changed, the determination unit 24 stores the change contents of the selling price in the change DB 38. If a record in which the column code, goods code, and HC classification are the same as in the input and output data is already present in the change DB 38, the determination unit 24 updates the stored information by using new change contents. The determination unit 24 then stores the value, which represents the number of items of goods to be sold at a reduced selling price and which represents the number of items remaining in inventory of the goods whose remaining number of retention days is that used for the determination of a selling price after the discount, in “discount-sale-available item count” of the change DB 38.

Next, in S27, the determination unit 24 notifies the sales control unit 40 of the column code of the column 46, in which goods whose selling price is to be changed are stored, and the selling price after the change. Thus, the sales control unit 40 performs control, such as changing the display of the digital indicator 42A of interest, for example, as illustrated in a state B in FIG. 12. A message indicating that goods are being sold at a discount may be displayed on the display 42C.

Next, in S28, the determination unit 24 acquires a sales apparatus code and a location code from the setting DB 32. The determination unit 24 then creates change information including information on the sales apparatus code, location code, goods code, HC classification, selling prices before and after the change, and the number of items available for a discounted sale. The determination unit 24 then acquires a notification destination from the setting DB 32 and transmits the created change information to an outside server, which is the notification destination. Thus, the selling-price change process is complete.

Next, the selling stop process illustrated in FIG. 15 will be described.

In S31, the management unit 22 acquires sales data including information on the column code, sales date, goods code, and HC classification from the sales control unit 40.

Next, in S32, for one piece of sales data, the management unit 22 subtracts one from the value of “remains in inventory” of the corresponding record in the inventory DB 36 by performing processing similar to that in S12 of the above supply management process (FIG. 13).

Next, in S33, the stopping control unit 26 receives sales data acquired by the management unit 22 in the above S31. Then, for one piece of sales data, the stopping control unit 26 subtracts one from the value of “discounted-sale remains in inventory” of a record in the change DB 38 in which “column code”, “goods code”, and “HC classification” are the same as in the sales data.

Next, in S34, the stopping control unit 26 determines whether there are goods whose value of “discounted-sale remains in inventory” has become zero in the change DB 38. If there are goods whose value of “discounted-sale remains in inventory” has become zero, the process proceeds to S35. If there are no goods whose value of “discounted-sale remains in inventory” has become zero, the selling stop process is complete.

In S35, the stopping control unit 26 sends a sales stop command for stopping sales of goods whose value of “discounted-sale remains in inventory” has become zero to the sales control unit 40. Thereby, the sales control unit 40 controls the goods of interest so that the goods of interest will not be sold. For example, the sales control unit 40 causes characters “in preparation” to be lighted on by the lamp 42B corresponding to the goods of interest, as illustrated in a state C in FIG. 12.

Next, in S36, the stopping control unit 26 determines whether a predetermined time has elapsed without any purchase action of the user on the sales apparatus 10 after sending a selling stop command. If the determination is affirmative, the process proceeds to S37. If the determination is negative, the determination of this step is repeated.

In S37 to S39, the processing of changing the selling price of goods of interest is performed by the process similar to that in S24, S27, and S28 of the above selling-price change process, and the selling stop process is complete. The selling price determined in S37 is a selling price whose discount rate is lower than that of the current selling price in accordance with the number of items remaining in inventory for each remaining number of retention days. If there are no items remaining in inventory of goods whose remaining number of retention days satisfies the conditions of a discounted sale, the determination unit 24 determines that the selling price is to be changed to the list price.

As described above, for goods that are being sold at a discount in accordance with the remaining number of retention days, a sales apparatus according to the present embodiment temporarily stops selling the goods when the number of items available for a discounted sale has become zero. This enables disadvantages, such as continued sales at a reduced selling price even when discount is unnecessary, and a change in selling price while a plurality of items are being continuously purchased or immediately before purchase is made, to be reduced, resulting in sales control according to the situation.

When no purchase action of the user has been detected for at least a predetermined time, a sales apparatus according to this embodiment changes the selling price of goods whose selling is stopped. This makes it possible to continuously sell goods at a suitable selling price in accordance with the situation while reducing disadvantages as mentioned above.

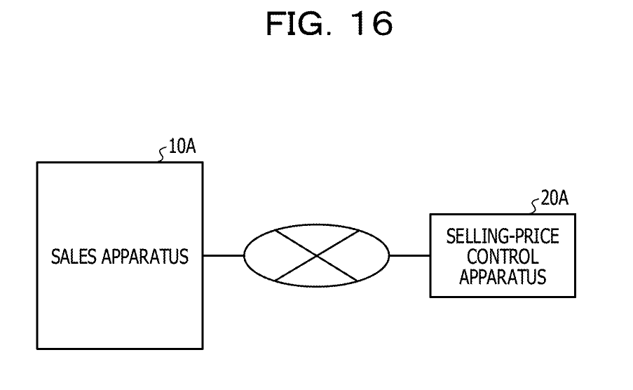

In the above embodiment, the case where the selling-price control apparatus 20 is mounted in the sales apparatus 10 has been described; however, the disclosed techniques are not limited to this. For example, as illustrated in FIG. 16, a selling-price control apparatus 20A may be configured as an outside apparatus coupled to the sales apparatus 10 through a network. In this case, the selling-price control apparatus 20A may receive sales data, input and output data, and the like column by column from the sales control unit 40 of the sales apparatus 10A and execute the supply management process, selling-price change process, and selling stop process described above. Further, the selling-price control apparatus 20A may transmit selling-price change information, a selling stop instruction, and the like to the sales control unit 40 of the sales apparatus 10A. In this case, the selling-price control apparatus 20A is an example of the control apparatus of the disclosed techniques.

In the above embodiment, the case where the selling price of goods is assumed to be paid in money has been described; however, the disclosed techniques are not limited to this. For example, the disclosed techniques are applicable to the case where payment is made with points other than money. When the units of points are different from the units of money, minus points corresponding to a discount amount may be set in the condition DB 34.

In the above embodiment, the case where the sales apparatus is a beverage vending machine has been described by way of example; however, the disclosed techniques are not limited to this. The disclosed techniques are applicable to vending machines for other foods and are also applicable to goods having a limitation corresponding to a sell-by date other than foods, for example, newspapers, magazines, season goods, goods for time-limited sales, and the like.

In the above embodiment, the case where a supply date is stored in the inventory DB 36 and the remaining number of retention days is calculated based on the supply date has been described; however, the disclosed techniques are not limited to this. For example, instead of “supply date” of the inventory DB 36, the last day of a retention period based on the supply date is stored, and the remaining number of retention days may be calculated from a difference between the date at the time of calculation of the remaining number of retention days and the date of the last day.

The selling price may be controllable in a specific situation, such as an event, by setting, for example, +20 yen, which is the amount of money corresponding to an increase in price, in the discount amount field of the condition DB 34.

In the above embodiment, a manner in which the selling-price control program 60 is stored in advance (installed) in the storage unit 53 has been described; however, the disclosed techniques are not limited to this. Programs according to the disclosed techniques may be provided in a form in which the programs are stored on recording media such as compact disc read-only memory (CD-ROM), digital versatile disc ROM (DVD-ROM), universal serial bus (USB) memory, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A sales apparatus, comprising:
a receptacle;
a column that houses a plurality of goods to be sold and transports the plurality of goods to the receptacle;
a memory in which inventory information indicating an inventory status of the column of the plurality of goods is stored; and
a processor coupled to the memory and configured to:
update the inventory information each time the plurality of goods are transported from the column to the receptacle, and
when referencing the inventory information and detecting that, among a plurality of specific goods in inventory among the plurality of goods, a plurality of target goods to be subject to selling processing at a first selling price are out of inventory, suppress transportation processing of the plurality of specific goods from the column to the receptacle even when the plurality of specific goods in inventory remain.

2. The sales apparatus according to claim 1,
wherein the plurality of target goods are goods for which a given time period has elapsed during which the goods have not been sold since restocking, among the plurality of specific goods.

3. The sales apparatus according to claim 1,
wherein the plurality of target goods are goods for which a time period remaining until a sell-by date is less than or equal to a given time period, among the specific goods.

4. The sales apparatus according to claim 2, wherein the inventory status indicates:
which of goods among the plurality of specific goods in inventory have been restocked and when the goods, among the plurality of specific goods in inventory, were restocked, or
which of goods, among the plurality of specific goods in inventory will reach a sell-by date and the corresponding sell-by date.

5. The sales apparatus according to claim 1, wherein the processor is configured to:
execute change processing for changing a selling price of the plurality of specific goods from the first selling price to a second selling price, and
when, after the change processing, there is no detection of a person by a person sensor for a given time or longer, no detection of an operation of an operation unit for a given time or longer, or no detection of display on a goods purchase screen for a given time or longer, change the selling price of the plurality of specific goods from the second selling price to the first selling price or a third selling price.

6. The sales apparatus according to claim 5,
wherein the second selling price is lower than the first selling price.

7. The sales apparatus according to claim 5, wherein the processor is configured to
when detecting that, out of the plurality of specific goods in inventory, a plurality of goods to be sold at the second selling price are out of inventory, change the selling price of the plurality of specific goods from the second selling price to the first selling price or the third selling price.

8. A control method executed by a processor included in a sales apparatus that sells a plurality of goods to be sold, the sales apparatus including a receptacle, a column that houses the plurality of goods and transports the plurality of goods to the receptacle, and a memory in which inventory information indicating an inventory status in the column of the plurality of goods is stored, the control method comprising:
updating the inventory information each time the plurality of goods are transported from the column to the receptacle; and
when referencing the inventory information and detecting that, among a plurality of specific goods in inventory among the plurality of goods, a plurality of target goods to be subject to selling processing at a first selling price are out of inventory, suppress transportation processing of the plurality of specific goods from the column to the receptacle even when the plurality of specific goods in inventory remain.

9. The control method according to claim 8,
wherein the plurality of target goods are goods for which a given time period has elapsed during which the goods have not been sold since restocking, among the plurality of specific goods.

10. The control method according to claim 8,
wherein the plurality of target goods are goods for which a time period remaining until a sell-by date is less than or equal to a given time period, among the specific goods.

11. The control method according to claim 9, wherein the inventory status indicates:
which of goods among the plurality of specific goods in inventory have been restocked and when the goods, among the plurality of specific goods in inventory, were restocked, or
which of goods, among the plurality of specific goods in inventory will reach a sell-by date and the corresponding sell-by date.

12. The control method according to claim 8, further comprises:
executing change processing for changing a selling price of the plurality of specific goods from the first selling price to a second selling price, and
when, after the change processing, there is no detection of a person by a person sensor for a given time or longer, no detection of an operation of an operation unit for a given time or longer, or no detection of display on a goods purchase screen for a given time or longer, changing the selling price of the plurality of specific goods from the second selling price to the first selling price or a third selling price.

13. The control method according to claim 12,
wherein the second selling price is lower than the first selling price.

14. A non-transitory computer-readable recording medium storing a program that causes a processor included in a sales apparatus that sells a plurality of goods to be sold to execute a process, the sales apparatus including a receptacle, a column that houses the plurality of goods and transports the plurality of goods to the receptacle, and a memory in which inventory information indicating an inventory status in the column of the plurality of goods is stored, the process comprising:
updating the inventory information each time the plurality of goods are transported from the column to the receptacle; and
when referencing the inventory information and detecting that, among a plurality of specific goods in inventory among the plurality of goods, the plurality of target goods to be subject to selling processing at a first selling price are out of inventory, suppress transportation processing of the plurality of specific goods from the column to the receptacle even when the plurality of specific goods in inventory remain.
